(19) United States
(12) Patent Application Publication
(10) Pub. No.: US 2018/0144370 A1
(43) Pub. Date: May 24, 2018

(54) SIGNAL BASED ECPM PREDICTION AND BIDDING

(71) Applicant: Conversant, LLC, Chicago, IL (US)

(72) Inventor: Shuanglong Wang, Chicago, IL (US)

(21) Appl. No.: 15/820,841

(22) Filed: Nov. 22, 2017

Related U.S. Application Data
(60) Provisional application No. 62/425,161, filed on Nov. 22, 2016.

(51) Int. Cl. G06Q 30/02; G06N 7/00

(52) U.S. Cl. CPC G06Q 30/0269; G06F 17/12; G06Q 30/0277; G06N 7/005

(57) ABSTRACT

A system for predicting behavior of a visitor to a website includes an advertising server configured to provide an advertisement to the visitor and a processor operatively associated with the advertising server. The processor is configured to determine a current state of behavior for the visitor at the website, the current state of behavior being one of an active state and an inactive state, wherein determination of if the visitor is in the active state is based on receipt of a signifying signal, by the processor. The processor is further configured to determine a probability that the visitor transitions from the active state to a conversion state based, at least, on a probability of conversion from the active state to a conversion based, at least, on a partially hidden Markov Chain model of transitions between the inactive state, the active state, and the conversion.

### TECHNICAL FIELD

The present disclosure relates generally to analytics-based online advertising and, more particularly, to determining bidding strategy by predicting the behavior of visitors to a website.

### BACKGROUND

In the field of online advertising, it is important, to clients and their adtech partners, to determine the appropriate amount of money to bid for any targeted advertisement opportunity. Particularly, with respect to bidding, it is important to determine the value of an impression, which is presented to a visitor to a website.

In particular, it has often proven difficult to tune the value of an impression to specific website visitors, on an advertising campaign specific level. Accordingly, systems and methods for predicting behavior of such visitors, to a website, that predict behavior of the visitor, are desired.

### SUMMARY

In accordance with one aspect of the disclosure, a system for predicting behavior of a visitor to a website is disclosed. The system includes an advertising server configured to provide an advertisement to the visitor, the advertisement displayed at the website on a computing device used by the visitor. The system further includes a data communications system communicatively coupling the advertising server with the computing device and a processor operatively associated with the advertising server. The processor is configured to determine a current state of behavior for the visitor at the website, the current state of behavior being one of an active state and an inactive state, wherein determination of if the visitor is in the active state is based on receipt of a signifying signal, by the processor, and wherein determination of if the visitor is in the inactive state is based on a lack of receipt of the signifying signal, within a given period of time. The processor is further configured to determine a probability that the visitor transitions from the active state to a conversion state based, at least, on a probability of conversion (p_{c}) from the active state to a conversion based, at least, on a partially hidden Markov Chain model of transitions between the inactive state, the active state, and the conversion.

In accordance with another aspect of the disclosure, a system for targeting a visitor to a website with one or more digital advertisements is disclosed. The system includes an advertising server configured to provide the one or more digital advertisements to the visitor, the advertisement displayed at the website on a computing device used by the visitor. The system further includes a data communications system communicatively coupling the advertising server with the computing device and a processor operatively associated with the advertising server. The processor is configured to determine a current state of behavior for the visitor at the website, the current state of behavior being one of an active state and an inactive state, wherein determination of if the visitor is in the active state is based on receipt of a signifying signal, by the processor, and wherein determination of if the visitor is in the inactive state is based on a lack of receipt of the signifying signal, within a given period of time. The processor is further configured to determine a probability that the visitor transitions from the active state to a conversion state based, at least, on a probability of conversion (p_{c}) from the active state to a conversion based, at least, on a partially hidden Markov Chain model of transitions between the inactive state, the active state, and the conversion. The advertising server is configured to perform a bidding process for at least one of the one or more digital advertisements for at least one advertising client based, at least, on the probability that the visitor transitions from the active state to the conversion state

### BRIEF DESCRIPTION OF THE DRAWINGS

FIG. 1 is schematic diagram illustrating systems for presenting advertising to a visitor to a website, and environments in which said systems may operate, in accordance with an embodiment of the disclosure.

FIG. 2 is a state diagram illustrating transitions between inactive, active, and conversion states, in accordance with an embodiment of the disclosure.

FIG. 3 a schematic depiction of physical components which may be utilized to, at least in part, embody computing components described within the disclosure, in accordance with the present disclosure.

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

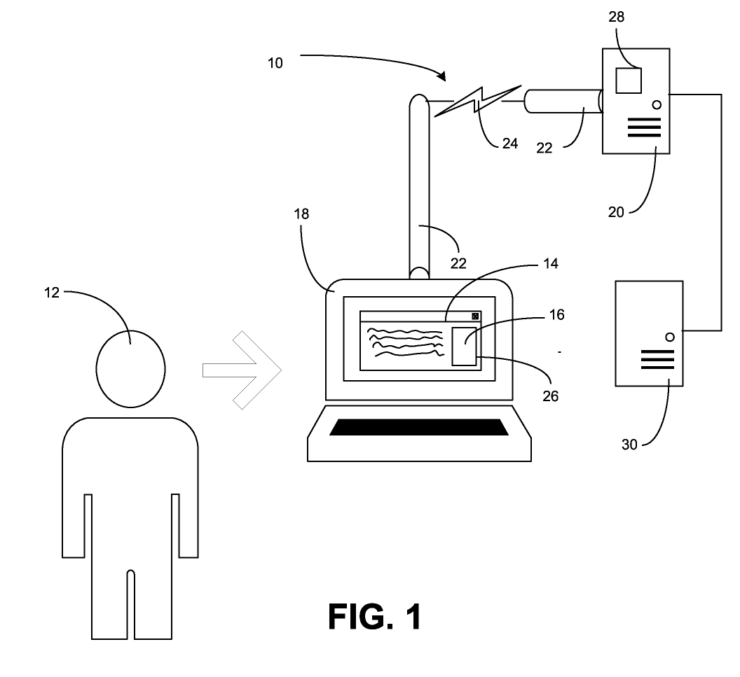

Turning now to the drawings and with specific reference to FIG. 1, a system 10 for predicting behavior of a visitor 12 to a website 14 and/or for serving an advertisement 16 to the visitor 12 based on such behavior, is illustrated. The system 10 includes an advertising server 20 (“ad server” 20) in communication with a computing device 18, which is utilized by the visitor 12 to experience the website 14. The visitor 12 is any human user that is capable of interacting with the computing device 18, in any sensory capacity, and the computing device 18 is any computing device, or combinations thereof, capable of being connected to a network and presenting the website 14 to the visitor 12 such as, but not limited to, desktop computers, laptop computers, tablets, mobile phones, video game consoles, set top boxes, servers, smart monitors, and the like. Further, while the website 14 and the advertisement 16 are depicted as visual elements displayed to the visitor 12, it is contemplated that the website 14 and advertisement 16 may be of any media form perceptible to the user, such as, but not limited to, audio, video, and/or interactive advertisements.

The ad server 20 interacts with the website 14 and the computing device 18 via data linkage 22, which may involve connection of both the ad server 20 and the computing device 18 to a common network 24 (e.g., the Internet). In determining whether or not to serve the advertisement 16 to the visitor 12 in an ad space 26 of the website 14, the ad server 20 is involved with a bidding process, in which advertising inventory is bought and sold on a per-impression basis via programmatic instantaneous action. To that end, the ad server 20 may be in communication with a client server 30 during such bidding process, and the client server 30 may provide content for the advertisement 16.

Statistical modeling is very important in the bidding process, particularly in analytics designs for retargeting the visitor 12. In generating a targeting or retargeting probability model, it is assumed that a processor 28 of the ad server 20 (e.g., a digital signal processor (DSP)) can observe some form of signification signal associated with the visitor, prior to a “conversion” by the visitor 12 within the environs of the website 14. A “signification signal” or “signifying signal” may refer to, for example, multiple registrations or re-registrations of the website 14 and/or ad-click servers associated therewith, within a given period of time. Further, a “conversion” may refer to a desired outcome of advertisement presentation, such as the visitor 12 clicking on the advertisement 16 and/or the visitor 12 ultimately purchasing something from the client who is responsible for the ad. Accordingly, prediction of whether or not an advertisement 16 presentation will result in conversion is essential to determining bidding characteristics.

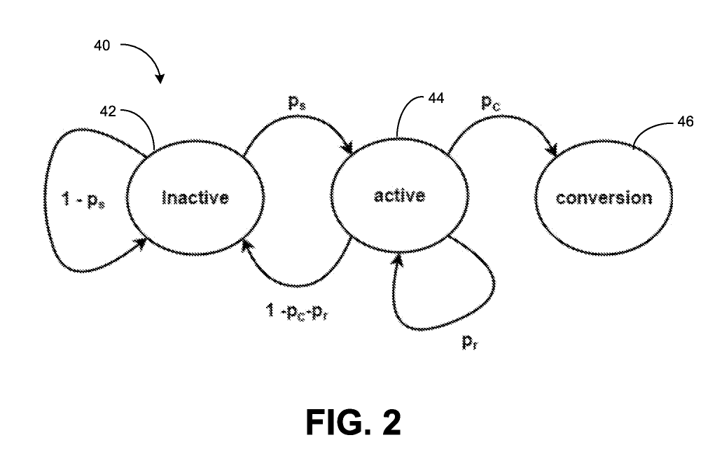

In predictive modeling of behavior of the visitor 12, a predictive model 40 may be generated by observing and predicting transitions between “states” of the visitor 12 activity at the website 14, as illustrated in the state diagram for the predictive model 40 in FIG. 2. The model 40 uses probability to predict conversion based on conversion behavior of the visitor 12 when in an inactive state 42, an active state 44, and/or a conversion event 46 occurring. The inactive state occurs for the visitor 12 when it is unclear if the visitor 12 has any interest in what the client is advertising. The active state is based on whether the ad server 20, and the processor 28 thereof, detects a signification signal for the visitor 12. Accordingly, it is assumed within the model 40 that to achieve the conversion 46, the visitor 12 must transition to the conversion 46 from the active state 44. Further, in order to achieve the final conversion, at some point in time, the visitor 12 must have moved from the inactive state 42 to the active state 44, indicating an increase in probability for the conversion 46.

Once the visitor 12 arrives at the active state 44 from the inactive state 42, the visitor 12 will either make the conversion 46, remain at the active state 44, or revert to the inactive state 42. Among these transitions, it is only the conversion behavior that is observed by the ad server 20, while the other two transitions remain hidden. Such hidden properties of the model 40 capture the hidden nature of the visitor 12 behavior after the signifying signal. The recurrence of the active state 44 comes from the intuition that the time between the conversion 46 and the signifying signal, which produces the active state 44, is usually random. The recurrence of the active state, however, would produce an exponential distribution of the conversion time, after the signifying signal.

The model 40 is a partially hidden Markov Chain model that may be designed to retarget the visitor 12, for advertising, by the client. A Markov Chain model, generally, involves making predictions for the future of the conversion 46 based solely on its present state and probability of current and past state transitions. If the visitor 12 is in the inactive state 42, he/she will convert to the active state 44 with a probability pₛ, which, is represented as a value between 0 and 1. Accordingly, the probability that the visitor remains in the inactive state 42 is represented by 1−pₛ. If the visitor 12 begins in the active state 44, in each period of analysis, the visitor would have a probability p_{c} of transitioning to the conversion 46, otherwise the visitor would stay at the active state 44 with a remain probability of pᵣ, or revert to the inactive state 42 with a probability of 1−p_{c}−pᵣ.

Various assumptions are made for the model to perform accurately. Particularly, it is assumed that an advertising campaign for the advertisement 16 has a finite amount of time in which each targeted visitor 12 will convert. Secondly, it is assumed that the signifying signal indicative of the active state 44 is observable. Further, it is assumed that there is a random time for a signal that follows a geometric distribution and there is a random time between a signal and a conversion that follows a geometric distribution, in accordance with the memoryless property of the Markov Chain of the model 40. Lastly, it is to be assumed that all visitors 14 are following the same conversion time distribution, such that the processor 28 does not need to invest in learning the conversion time behavior at the visitor level and aggregated behavior is sufficient.

After receiving a signifying signal at the ad server 20, the processor 28 is unsure whether the visitor 12 has reverted to the inactive state 42, or remained in the active state 44. Therefore, a Belief Calculation (Bₙ) is determined to generate the probability of the user remaining at the active state 44, given that no additional signal has been detected by the processor 28. Accordingly, for the model 40, having a series with number of periods “n”:

$${B}_{n} = {P}_{n} ( still in active state \text{\textbar} no further signal or conversion after a signal ) = \frac{1 - {p}_{r} - {p}_{s}}{{( 1 - {p}_{r} - {p}_{c} ) [ \frac{{p}_{r}}{1 - {p}_{s}} ]}^{- n} + ( {p}_{c} - {p}_{s} )}$$

As with this model calculation, Bₙ decreases along time and, sometimes (e.g., when 1−pₛ<pᵣ), Bn converges to a nonzero constant.

After calculating the probability of being active state 44 with the Belief Calculation, the probability conversion 46 after a single bid should be determined. In an infinite amount of time, all visitors 12 to the website 14 will have converted, in the context of the model 40, during an infinite amount of time. However, within the model, it is assumed that the campaign is of a finite time. Therefore, the model 40 needs to know how much time to wait before next impression is delivered, as the ad server 20 and/or instructions from the client may apply sophisticated control over bidding price and frequency cap. The model 40 can estimate the waiting time of an impression by the impression history and also dynamically adjust it. The waiting time is denoted asK.

Beginning with recognition of the signifying signal that triggers transition to the active state 44, without serving impression in n-1 periods without conversion, serving one impression and wait for K more periods would give the conversion probability:

Bₙ₋₁P_{A}(K)+(1−Bₙ₋₁)P_{I}(K)

Where P_{A} (n) is the probability of conversion in n periods given, that the starting state is the active state 44, while P_{I}(n) gives the value for the inactive state 42. Both formulas can be updated recursively, as follows:

P_{A}(0)=0,P_{I}(0)=0

P_{A}(n+1)=p_{c}+pᵣP_{A}(n)+(1−pᵣ−p_{c})P_{I}(n)

P_{I}(n+1)=pₛP_{A}(n)+(1−pₛ)P_{I}(n)

Further, in the process of modeling via the model 40, the Belief Calculation Bₙ can be dynamically updated, per period, to obtain a more accurate model for said calculation. For example, Bₙ can be dynamically updated by utilizing recursion, such that

Bₙ=Bₙ₋₁pᵣ/[Bₙ₋₁(1−p_{c})+(1−Bₙ₋₁)(1−pₛ)]

wherein B₀=1.

In order to more accurately and predictively model parameters, certain statistics derived in the model can be matched with samples obtained in reality and recorded at the ad server 20. For example, a mean number of periods (T_{sig}), in which the visitor transitions from the inactive state 42 to the active state 44, can be estimated as:

$${T}_{sig} = \frac{1}{{p}_{s}} .$$

Further, parameters for post-signifying signal analysis (active state 44) can be estimated, as well, such as the probability of achieving conversion 46 prior to another signifying signal occurring (P_{cvt}) can be defined as

$${P}_{cvt} = \frac{{p}_{c}}{1 - {p}_{r}} ,$$

a mean number of periods before conversion 46, without additional signal, (T_{c}) can be defined as

$${T}_{c} = \frac{1}{1 - {p}_{r}} ,$$

probability of re-signal before conversion can be estimated as

$$\frac{1 - {p}_{r} - {p}_{c}}{1 - {p}_{r}} ,$$

and a mean number of periods of resignal without conversion can be estimated as

$$\frac{1}{{p}_{r} + {p}_{s} - 1} ( \frac{{p}_{s} {p}_{r}}{1 - {p}_{r}} - \frac{( 1 - {p}_{s} ) ( 1 - {p}_{r} )}{{p}_{s}} ) + 1 \approx \frac{1}{{p}_{s}} .$$

In prior methods for determining probability for conversion, a data server may have a conversion probability score defined for the specific visitor to the website. However, in the disclosed systems and methods, the processor 28 assumes that all visitors 14 would follow the same conversion and signal time distribution. Such an assumption in modeling allows conversion time to only depend on the parameter pᵣ and the signal time only depends on the parameter pₛ. After optimizing pᵣ, the conversion probability only depends on p_{c}. All of this makes the parameter estimation simpler. Further, based on the aforementioned equations for parameter optimizations, the various parameters can be measured from standard statistics.

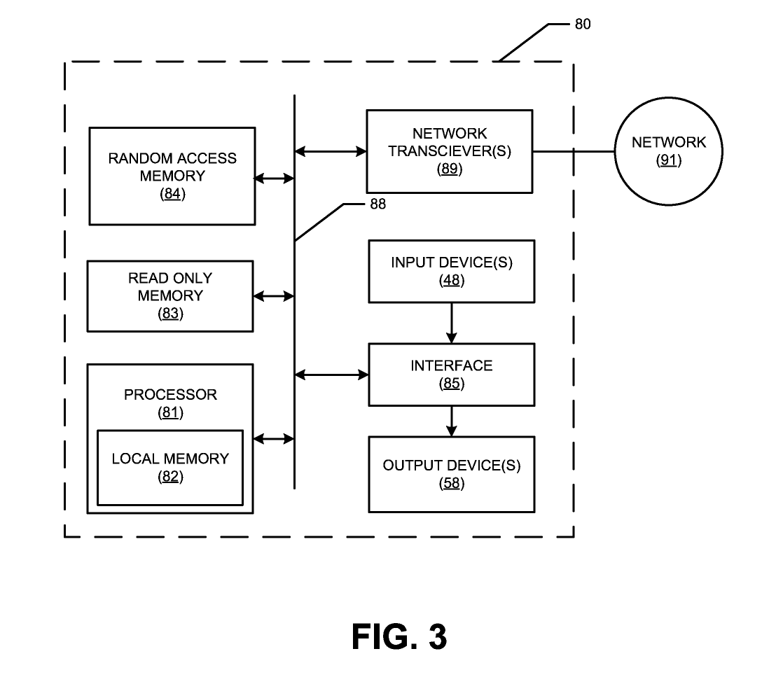

FIG. 3 is a block diagram of a controller 80 that may embody, at least in part, the ad server 20 as a computer capable of executing instructions to perform the systems and methods disclosed herein. Additionally, the computing device may be exemplary of a device used as the computing device 18 and/or the client server 30. The controller 80 may be, for example, a server, a personal computer, or any other type of computing device. The controller 80 of the instant example includes a processor 81. For example, the processor 81 may be implemented by one or more microprocessors or controllers from any desired family or manufacturer.

The processor 81 may include a local memory 82 and is in communication with a main memory including a read only memory 83 and a random access memory 84 via a bus 88. The random access memory 84 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 83 may be implemented by a hard drive, flash memory and/or any other desired type of memory device.

Further, the controller 80 may also include an interface circuit 85. The interface circuit 85 may be implemented by any type of interface standard, such as, for example, an Ethernet interface, a universal serial bus (USB), and/or a PCI express interface. One or more input device(s) 48 may be connected to the interface circuit 85. The input device(s) 48 permit a user to enter data and commands into the processor 81 (e.g., input data for the parameters 61, toolpath instructions 78, etc.). The input device(s) 48 can be implemented by, for example, a keyboard, a mouse, a touchscreen, a track-pad, a trackball, and/or a voice recognition system. One or more output devices 58 may also be connected to the interface circuit 85. The output devices 58 can be implemented by, for example, display devices for associated data (e.g., a liquid crystal display, a cathode ray tube display (CRT), etc.).

The controller 80 may include one or more network transceivers 89 for connecting to a network 91, such as the Internet, a WLAN, a LAN, a personal network, or any other network for connecting the controller 80 or more other controllers, and/or other network capable devices. As such, the controller 80 may be embodied by a plurality of controllers 80.

As mentioned above the controller 80 may be used to execute machine readable instructions such examples, the machine readable instructions comprise a program for execution by a processor such as the processor 81 shown in the example controller 80. The processor 81 may be exemplary of the aforementioned processor 28. The program may be embodied in software stored on a tangible computer readable medium. Such computer readable medium as used herein refers to any non-transitory medium or combination of media that participates in providing instructions to a processor for execution. Such a medium comprises all computer readable media except for a transitory, propagating signal. For example, such computer readable medium may include a CD-ROM, a floppy disk, a hard drive, a digital versatile disk (DVD), a Blu-ray disk, or any other memory associated with the controller 80.

It will be appreciated that the present disclosure provides systems, methods, and apparatus determining bidding strategy by predicting the behavior of visitors to a website. While only certain embodiments have been set forth, alternatives and modifications will be apparent from the above description to those skilled in the art. These and other alternatives are considered equivalents and within the spirit and scope of this disclosure and the appended claims.

What is claimed is:

1. A system for predicting behavior of a visitor to a website, the system comprising:
an advertising server configured to provide an advertisement to the visitor, the advertisement displayed at the website on a computing device used by the visitor;
a data communications system communicatively coupling the advertising server with the computing device; and
a processor operatively associated with the advertising server and configured to
determine a current state of behavior for the visitor at the website, the current state of behavior being one of an active state and an inactive state, wherein determination of if the visitor is in the active state is based on receipt of a signifying signal, by the processor, and wherein determination of if the visitor is in the inactive state is based on a lack of receipt of the signifying signal, within a given period of time, and
determine a probability that the visitor transitions from the active state to a conversion state based, at least, on a probability of conversion (p_{c}) from the active state to a conversion based, at least, on a partially hidden Markov Chain model of transitions between the inactive state, the active state, and the conversion.

2. The system of claim 1, wherein the partially hidden Markov Chain model includes a belief calculation (Bₙ), which is a probability that the visitor remains in the active state, while the processor does not receive an additional signifying signal.

3. The system of claim 2, wherein Bₙ is defined as
$$Bn = \frac{1 - {p}_{r} - {p}_{s}}{{( 1 - {p}_{r} - {p}_{c} ) [ \frac{{p}_{r}}{1 - {p}_{s}} ]}^{- n} + ( {p}_{c} - {p}_{s} )}$$
wherein pᵣ is the probability that the visitor remains in the active state and pₛ is the probability that the visitor transitions from the inactive state to the active state.

4. The system of claim 1, wherein the partially hidden Markov Chain model includes determining an estimated mean number of periods (T_{sig}), for the partially hidden Markov Chain model, in which the visitor should transition from the inactive state to the active state, wherein T_{sig} is defined as
$${T}_{sig} = \frac{1}{{p}_{s}} ,$$
wherein pₛ is the probability that the visitor transitions from the inactive state to the active state.

5. The system of claim 1, wherein the partially hidden Markov Chain model includes a probability of achieving conversion prior to another signifying signal occurring (P_{cvt}), wherein P_{cvt} is defined as
$${P}_{cvt} = \frac{{p}_{c}}{1 - {p}_{r}} ,$$
wherein pᵣ is the probability that the visitor remains in the active state.

6. The system of claim 1, wherein the partially hidden Markov Chain model includes determining a mean number of periods before conversion, without an additional signifying signal (T_{c}), for the partially hidden Markov Chain model, wherein T_{c} is defined as
$${T}_{c} = \frac{1}{1 - {p}_{r}} ,$$
wherein pᵣ is the probability that the visitor remains in the active state.

7. The system of claim 1, wherein the partially hidden Markov Chain model includes a probability of re-signal before conversion, for the partially hidden Markov Chain model, as
$$\frac{1 - {p}_{r} - {p}_{c}}{1 - {p}_{r}} ,$$
wherein pᵣ is the probability that the visitor remains in the active state.

8. The system of claim 1, wherein the partially hidden Markov Chain model includes a mean number of periods of resignal without conversion, for the partially hidden Markov Chain model, as
$$\frac{1}{{p}_{r} + {p}_{s} - 1} ( \frac{{p}_{s} {p}_{r}}{1 - {p}_{r}} - \frac{( 1 - {p}_{s} ) ( 1 - {p}_{r} )}{{p}_{s}} ) + 1 \approx \frac{1}{{p}_{s}} ,$$
wherein pᵣ is the probability that the visitor remains in the active state and pₛ is the probability that the visitor transitions from the inactive state to the active state.

9. A system for targeting a visitor to a website with one or more digital advertisements, the system comprising:
an advertising server configured to provide the one or more digital advertisement to the visitor, the advertisement displayed at the website on a computing device used by the visitor;
a data communications system communicatively coupling the advertising server with the computing device; and
a processor operatively associated with the advertising server and configured to
determine a current state of behavior for the visitor at the website, the current state of behavior being one of an active state and an inactive state, wherein determination of if the visitor is in the active state is based on receipt of a signifying signal, by the processor, and wherein determination of if the visitor is in the inactive state is based on a lack of receipt of the signifying signal, within a given period of time, and
determine a probability that the visitor transitions from the active state to a conversion state based, at least, on a probability of conversion (p_{c}) from the active state to a conversion based, at least, on a partially hidden Markov Chain model of transitions between the inactive state, the active state, and the conversion, and
wherein the advertising server is configured to perform a bidding process for at least one of the one or more digital advertisements for at least one advertising client based, at least, on the probability that the visitor transitions from the active state to the conversion state.

10. A method of predicting behavior of a visitor to a website, the method comprising:
determining, using a processor, a current state of behavior for the visitor at the website, the current state of behavior being one of an active state and an inactive state, wherein determination of if the visitor is in the active state is based on receipt of a signifying signal, by the processor, and wherein determination of if the visitor is in the inactive state is based on a lack of receipt of the signifying signal, within a given period of time; and
determining, using the processor, the probability that the visitor transitions from the active state to a conversion state based, at least, on a probability of conversion (p_{c}) from the active state to a conversion based, at least, on a partially hidden Markov Chain model of transitions between the inactive state, the active state, and the conversion.

11. The method of claim 10, further comprising determining a belief calculation (Bₙ), for the partially hidden Markov Chain model, which is a probability that the visitor remains in the active state, while the processor does not receive an additional signifying signal.

12. The method of claim 11, wherein Bₙ is defined as
$$Bn = \frac{1 - {p}_{r} - {p}_{s}}{{( 1 - {p}_{r} - {p}_{c} ) [ \frac{{p}_{r}}{1 - {p}_{s}} ]}^{- n} + ( {p}_{c} - {p}_{s} )}$$
wherein pᵣ is the probability that the visitor remains in the active state and pₛ is the probability that the visitor transitions from the inactive state to the active state.

13. The method of claim 10, further comprising determining an estimated mean number of periods (T_{sig}), for the partially hidden Markov Chain model, in which the visitor should transition from the inactive state to the active state, wherein T_{sig} is defined as
$${T}_{sig} = \frac{1}{{p}_{s}} ,$$
wherein pₛ is the probability that the visitor transitions from the inactive state to the active state.

14. The method of claim 10, further comprising determining a probability of achieving conversion prior to another signifying signal occurring (P_{cvt}), wherein P_{cvt} is defined as
$${P}_{cvt} = \frac{{p}_{c}}{1 - {p}_{r}} ,$$
wherein pᵣ is the probability that the visitor remains in the active state.

15. The method of claim 10, further comprising determining a mean number of periods before conversion, without an additional signifying signal (T_{c}), for the partially hidden Markov Chain model, wherein T_{c} is defined as
$${T}_{c} = \frac{1}{1 - {p}_{r}} ,$$
wherein pᵣ is the probability that the visitor remains in the active state.

16. The method of claim 10, further comprising determining a probability of re-signal before conversion, for the partially hidden Markov Chain model, as
$$\frac{1 - {p}_{r} - {p}_{c}}{1 - {p}_{r}} ,$$
wherein pᵣ is the probability that the visitor remains in the active state.

17. The method of claim 10, further comprising estimating a mean number of periods of resignal without conversion, for the partially hidden Markov Chain model, as
$$\frac{1}{{p}_{r} + {p}_{s} - 1} ( \frac{{p}_{s} {p}_{r}}{1 - {p}_{r}} - \frac{( 1 - {p}_{s} ) ( 1 - {p}_{r} )}{{p}_{s}} ) + 1 \approx \frac{1}{{p}_{s}} ,$$
wherein pᵣ is the probability that the visitor remains in the active state and pₛ is the probability that the visitor transitions from the inactive state to the active state.
